(19) United States
(12) Patent Application Publication
(10) Pub. No.: US 2026/0072176 A1
(43) Pub. Date: Mar. 12, 2026

(54) INVERSION METHOD OF AEROSOL EXTINCTION COEFFICIENT BELOW CLOUDS BY LIDAR DETECTION

(71) Applicant: HEFEI INSTITUTES OF PHYSICAL SCIENCE, CAS, Hefei (CN)

(72) Inventors: Dong LIU, Hefei (CN); Zhisheng ZHANG, Hefei (CN); Zhiqiang KUANG, Hefei (CN); Decheng WU, Hefei (CN); Cheng LI, Hefei (CN); Qian DENG, Hefei (CN)

(21) Appl. No.: 19/276,250

(22) Filed: Jul. 22, 2025

(30) Foreign Application Priority Data
Sep. 9, 2024 (CN) 202411258273.6

(51) Int. Cl. G01S 17/95; G01S 7/48; G01S 7/497

(52) U.S. Cl. CPC G01S 17/95; G01S 7/4802; G01S 7/497

(57) ABSTRACT

An inversion method of an aerosol extinction coefficient below clouds by Light Detection and Ranging (LIDAR) detection includes: obtaining an aerosol extinction coefficient corresponding to an echo signal of LIDAR in a horizontal direction as a first calibration value EXT₁; determining a calibration point altitude at a cloud, and obtaining an atmospheric extinction coefficient corresponding to the calibration point altitude at the cloud base as a second calibration value EXT₀; obtaining a second extinction coefficient profile, and obtaining an extinction coefficient at a first altitude X as a second calibration value EXT_{X}, the first altitude X being greater than a blind area altitude; comparing the first calibration value EXT₁ with the second calibration value EXT_{X}, adjusting the second calibration value EXT₀ when |EXT_{X}−EXT₁|>EXT₁·δ, performing the obtaining a second extinction coefficient profile based on the adjusted second calibration value EXT₀ until |EXT_{X}−EXT₁|<EXT₁·δ, and outputting the second calibration value EXT_{X}, where δ is a relative error.

### CROSS REFERENCE TO RELATED APPLICATION

This patent application claims the benefit and priority of Chinese Patent Application No. 202411258273.6, filed with the China National Intellectual Property Administration on Sep. 9, 2024, the disclosure of which is incorporated by reference herein in its entirety as part of the present application.

### TECHNICAL FIELD

The present disclosure belongs to the technical field of Light Detection and Ranging (LIDAR), and in particular, to an inversion method of an aerosol extinction coefficient below clouds by LIDAR detection.

### BACKGROUND

LIDAR can not only monitor intensity changes of atmospheric aerosols, but also observe the vertical distribution of the atmospheric aerosols. Quantitative analysis can be performed after inversion of an observation result.

In vertical detection by LIDAR, an extinction coefficient of the atmospheric aerosols is obtained by inversion through the Fernald method in most cases. This requires that an altitude with a low content of atmospheric aerosols should be found as a calibration point altitude, and then a vertical aerosol extinction profile is obtained by means of Fernald backward integration. However, when there are low and thick clouds in the sky, echo signals of the LIDAR first increase sharply and then decrease, and finally tend to be background noise. In this case, laser cannot penetrate through the clouds, and it is impossible to determine the calibration point altitude required for inversion, thus making the inversion of aerosols below clouds difficult.

### SUMMARY

In order to solve the above technical problems, the present disclosure provides an inversion method of an aerosol extinction coefficient below clouds by LIDAR detection. The specific technical solution is as follows.

An inversion method of an aerosol extinction coefficient below clouds by LIDAR detection includes:
obtaining an aerosol extinction coefficient corresponding to an echo signal of LIDAR in a horizontal direction as a first calibration value EXT₁; determining a calibration point altitude at a cloud base according to a range-corrected squared signal at a set moment, and obtaining an atmospheric extinction coefficient corresponding to the calibration point altitude at the cloud base as a second calibration value EXT₀;
obtaining a second extinction coefficient profile based on the second calibration value EXT₀, and obtaining an extinction coefficient at a first altitude X as a second calibration value EXT_{X} according to the second extinction coefficient profile, the first altitude x being greater than a blind area altitude;
comparing the first calibration value EXT₁ with the second calibration value EXT_{X}, adjusting the second calibration value EXT₀ when |EXT_{X}−EXT₁|>EXT₁·δ, performing the obtaining a second extinction coefficient profile based on the adjusted second calibration value EXT₀ until |EXT_{X}−EXT₁|<EXT₁·8, and outputting the second calibration value EXT_{X}, where δ is a relative error.

In the inversion method of an aerosol extinction coefficient below clouds as described above, further, the obtaining an aerosol extinction coefficient corresponding to an echo signal of LIDAR in a horizontal direction as a first calibration value EXT₁ may include: obtaining, by a slope method, the aerosol extinction coefficient corresponding to the echo signal of the LIDAR in the horizontal direction as the first calibration value EXT₁.

In the inversion method of an aerosol extinction coefficient below clouds as described above, further, the obtaining, by a slope method, the aerosol extinction coefficient corresponding to the echo signal of the LIDAR in the horizontal direction as the first calibration value EXT₁ may include:
assuming that the atmosphere is horizontally homogeneous, defining an atmospheric backscattering echo signal power P(Y) at a horizontal range Y received by the LIDAR as:

$$P ( Y ) = {P}_{t} {kY}^{- 2} {β}_{H} exp ( - 2 {α}_{H} Y ) \qquad ( 2 )$$

where Pₜ represents a laser emission power (W), k represents a radar system constant (W·km³·Sr), β_{H} represents a horizontal atmospheric backscattering coefficient (km⁻¹Sr⁻¹), and CH represents a horizontal atmospheric extinction coefficient (km⁻¹);
multiplying both sides of the formula (2) by a range square, and then taking a logarithm and taking a derivative to obtain:

$$\frac{d ( ln [ P ( Y ) {Y}^{2} ] )}{dY} = \frac{1}{β} \frac{d β}{dY} - 2 {α}_{H} \qquad ( 3 )$$

under a condition of the horizontally homogeneous atmosphere, dβ/dz=0, and obtaining:

$${α}_{H} = - \frac{1}{2} \frac{d ( ln [ P ( Y ) {Y}^{2} ] )}{dY} \qquad ( 4 )$$

performing least squares fitting on ln[P(Y)Y²] and Y, determining a half of a slope as the horizontal atmospheric extinction coefficient α_{H}, and using α_{H} as the first calibration value EXT₁.

In the inversion method of an aerosol extinction coefficient below clouds as described above, further, the obtaining a second extinction coefficient profile based on the second calibration value EXT₀ may include: obtaining, by a Fernald backward integration method, the second extinction coefficient profile based on the second calibration value EXT₀.

In the inversion method of an aerosol extinction coefficient below clouds as described above, further, the horizontal range Y coverable by the LIDAR may be from 60 m to 1000 m.

In the inversion method of an aerosol extinction coefficient below clouds as described above, further, the first altitude X is greater than the blind area altitude, and the first altitude X may be from 60 m to 1000 m.

In the inversion method of an aerosol extinction coefficient below clouds as described above, further, the adjusting the second calibration value EXT₀ may include:

updating an increased iteration step size value of a LIDAR echo signal-molecular signal ratio R(Z_{C}) as a target value of the LIDAR echo signal-molecular signal ratio R(Z_{C}), obtaining a corresponding backscattering coefficient βₐ (Z_{C}) based on the target value of the LIDAR echo signal-molecular signal ratio R(Z_{C}), and obtaining a boundary value of the aerosol extinction coefficient αₐ(Z) using an aerosol extinction-to-backscatter ratio formula Sₐ, the boundary value of the aerosol extinction coefficient αₐ(Z_{C}) being the atmospheric extinction coefficient corresponding to the calibration point altitude at the cloud base and used as the second calibration value EXT₀ corresponding to the target value.

In the inversion method of an aerosol extinction coefficient below clouds as described above, further, the iteration step size value may range from 0.01 to 0.5.

In the inversion method of an aerosol extinction coefficient below clouds as described above, further, the LIDAR echo signal-molecular signal ratio R(Z_{C}) may have an initial value of 1.01.

In the inversion method of an aerosol extinction coefficient below clouds as described above, further, the relative error & may range from 0.01 to 0.05.

The present disclosure has the following advantages:
(1) The method of the present disclosure does not rely on an absolutely accurate calibration altitude and can obtain an inversion result of aerosols below clouds as long as a range of altitudes is determined. Based on an extinction coefficient graph obtained by the method of the present disclosure, the position of clouds and the distribution of aerosols below clouds can be inverted clearly, indicating that the method of the present disclosure can achieve accurate inversion of an aerosol extinction coefficient even in the presence of clouds.
(2) According to the present disclosure, in each iteration process, the calibration altitude remains unchanged, and the LIDAR echo signal-molecular signal ratio R(Z_{C}) needs to be adjusted according to the iteration step size value and iteration is performed continuously to achieve the purpose of continuously approaching a truth value.

### BRIEF DESCRIPTION OF THE DRAWINGS

FIG. 1 is a flowchart of an inversion method of an aerosol extinction coefficient below clouds by LIDAR detection of the present disclosure.

FIG. 2 illustrates a relational graph of a range-corrected signal vs an altitude at 11:30 on Apr. 9, 2024 (local time).

FIG. 3 is a flowchart of an inversion method of an aerosol extinction coefficient below clouds by LIDAR detection in an embodiment of the present disclosure.

FIG. 4 illustrates, in the upper part, an extinction coefficient graph obtained through inversion of an echo signal of portable infrared LIDAR using a traditional backward integration method, and in the lower part, an extinction coefficient graph obtained through inversion of a signal of portable infrared LIDAR using the method of the present disclosure.

FIG. 5 is a comparison diagram of LIDAR echo signals obtained using the traditional backward integration method and the method of the present disclosure.

FIG. 6 illustrates average relative errors at different altitudes by the method of the present disclosure.

### DETAILED DESCRIPTION OF THE EMBODIMENTS

The technical solutions in the embodiments of the present application will be described clearly and completely below with reference to the accompanying drawings in the embodiments of the present application. Apparently, the described embodiments are merely some rather than all of the embodiments of the present application. All other embodiments derived from the embodiments of the present application by a person of ordinary skill in the art without creative efforts should fall within the protection scope of the present application. In the description of the embodiments of the present disclosure, it should be understood that terms such as “first” and “second” are used merely for a descriptive purpose, and should not be construed as indicating or implying a relative importance, or implicitly indicating the number of indicated technical features. Therefore, the features defined by “first” and “second” can explicitly or implicitly include one or more features. In the description of the embodiments of the present disclosure, “a plurality of” means two or more, unless otherwise specifically defined.

In vertical detection by LIDAR, the Fernald method is usually utilized to invert an extinction coefficient of atmospheric aerosols. The extinction coefficient can be used to quantitatively analyze the content of aerosols. If aerosol and air molecular extinction coefficients at a calibration point altitude Z_{C} are known, according to a Fernald backward integration formula (see formula 1), four parameters need to be determined so as to obtain an atmospheric aerosol extinction coefficient αₐ(Z) according to a LIDAR echo signal. The four parameters are an aerosol extinction-to-backscatter ratio, Sₐ, an air molecular extinction-to-backscatter ratio Sₘ, an air molecular extinction coefficient αₘ (Z), and an aerosol extinction coefficient αₐ(Z_{C}) at the calibration point altitude Z_{C}.

A typical value of the aerosol extinction-to-backscatter ratio Sₐ=αₐ(Z)/βₐ(Z) is between 10 Sr and 90 Sr. The air molecular extinction-to-backscatter ratio Sₘ is typically a constant, i.e., Sₘ=8π/3. The air molecular extinction coefficient αₘ(Z) is typically obtained in the U.S. standard atmosphere mode. Generally, the first three parameters are easy to determine, while the aerosol extinction coefficient αₐ(Z) at the calibration point altitude Z_{C} is difficult to obtain accurately. The selection of the calibration point altitude typically needs to be determined with a clean atmosphere. The calibration point altitude Z_{C} is typically calculated from a minimum value of a ratio of a LIDAR range-corrected signal to a molecular backscattering coefficient (P(Z)·Z²/βₘ). A boundary value of the atmospheric aerosol extinction coefficient at the calibration point altitude Z is typically an empirical value, which is obtained by inversing an atmospheric aerosol backscattering coefficient βₐ (Z_{C}) at the calibration point altitude based on 1+βₐ (Z_{C})/βₘ (Z_{C})=1.01.

$${α}_{a} ( Z ) = - \frac{{S}_{a}}{{S}_{m}} \cdot {α}_{m} ( Z ) + \frac{P ( Z ) {Z}^{2} \cdot exp [ 2 ( \frac{{S}_{a}}{{S}_{m}} - 1 ) {\int }_{Z}^{{Z}_{c}} {α}_{m} ( {Z}^{′} ) {dZ}^{′} ]}{\begin{matrix}\frac{P ( {Z}_{c} ) {Z}^{2}}{{α}_{a} ( {Z}_{c} ) + \frac{{S}_{a}}{{S}_{m}} {α}_{m} ( {Z}_{c} )} + \\ 2 {\int }_{Z}^{{Z}_{c}} P ( {Z}^{′} ) {Z}^{′2} exp [ 2 ( \frac{{S}_{a}}{{S}_{m}} - 1 ) {\int }_{Z}^{{Z}_{c}} {α}_{m} ( {Z}^{″} ) {dZ}^{″} ] {dZ}^{′}\end{matrix}} \qquad ( 1 )$$

where P(Z) represents an atmospheric scattering echo signal power (W) at a range Z received by the LIDAR.

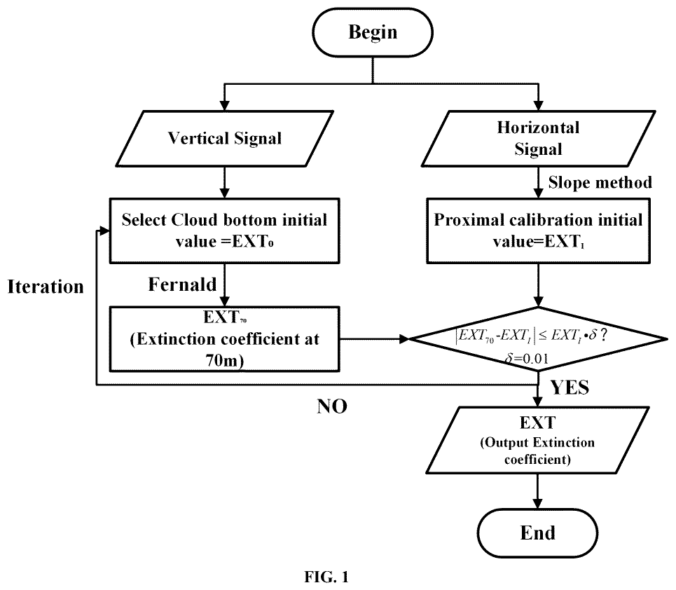

After analysis, when there are low and thick clouds in the sky, echo signals of the LIDAR first increase sharply and then decrease, and finally tend to be background noise. This signal trend indicates that laser does no penetrate through the clouds, which poses challenges to the determination of a calibrated altitude required for inversion. Therefore, a significant error of inversion of an aerosol extinction coefficient below clouds is introduced. Since the calibration point altitude cannot be determined, the true atmospheric aerosol extinction coefficient cannot be inverted using only the Fernald method. In this context, as shown in FIG. 1, the present disclosure provides an inversion method of an aerosol extinction coefficient below clouds by LIDAR detection, including the following steps.

An aerosol extinction coefficient corresponding to an echo signal of LIDAR in a horizontal direction is obtained as a first calibration value EXT₁; a calibration point altitude at a cloud base is determined according to a range-corrected squared signal at a set moment, and an atmospheric extinction coefficient corresponding to the calibration point altitude at the cloud base is obtained as a second calibration value EXT₀.

A second extinction coefficient profile is obtained based on the second calibration value EXT₀, and an extinction coefficient at a first altitude X is obtained as a second calibration value EXT_{X} according to the second extinction coefficient profile. The first altitude X is greater than a blind area altitude.

The first calibration value EXT₁ is compared with the second calibration value EXT_{X}; the second calibration value EXT₀ is adjusted when |EXT_{X}−EXT₁|>EXT₁·δ; the step of obtaining the second extinction coefficient profile is performed based on the adjusted second calibration value EXT₀ until |EXT_{X}−EXT₁|<EXT₁·δ, and the second calibration value EXT_{X} is output, where δ is a relative error.

In one embodiment, the step of obtaining the aerosol extinction coefficient corresponding to the echo signal of the LIDAR in the horizontal direction includes: the aerosol extinction coefficient corresponding to the echo signal of the LIDAR in the horizontal direction is obtained by a slope method.

In detail, assuming that the atmosphere is horizontally homogeneous, an atmospheric backscattering echo signal power P(Y) at a horizontal range Y received by the LIDAR is defined as:

$$P ( Y ) = {P}_{t} {kY}^{2} {β}_{H} exp ( - 2 {α}_{H} Y ) \qquad ( 2 )$$

where Pₜ represents a laser emission power (W), k represents a radar system constant (W·km³·Sr), β_{H} represents a horizontal atmospheric backscattering coefficient (km⁻¹Sr⁻¹), and α_{H} represents a horizontal atmospheric extinction coefficient (km⁻¹).

Both sides of the formula (2) are multiplied by a range square, and then a logarithm and a derivative are taken to obtain:

$$\frac{d ( ln [ P ( Y ) {Y}^{2} ] )}{dY} = \frac{1}{β} \frac{d β}{dY} - 2 {α}_{H} \qquad ( 3 )$$

Under a condition of the horizontally homogeneous atmosphere, dβ/dz=0. The following formula is obtained:

$${α}_{H} = - \frac{1}{2} \frac{d ( ln [ P ( Y ) {Y}^{2} ] )}{dY} \qquad ( 4 )$$

Least squares fitting is performed on ln[P(Y)Y²] and Y; a half of a slope is determined as the horizontal atmospheric extinction coefficient α_{H}, and α_{H} is used as the first calibration value EXT₁. In order to obtain accurate parameters, Y ranges from 60 m to 90 m. Since the extinction coefficient of air molecules is smaller than that of atmospheric aerosols by one order of magnitude nearby the ground. That is, it may be considered that the atmospheric aerosol extinction coefficient ay will not cause a too large error.

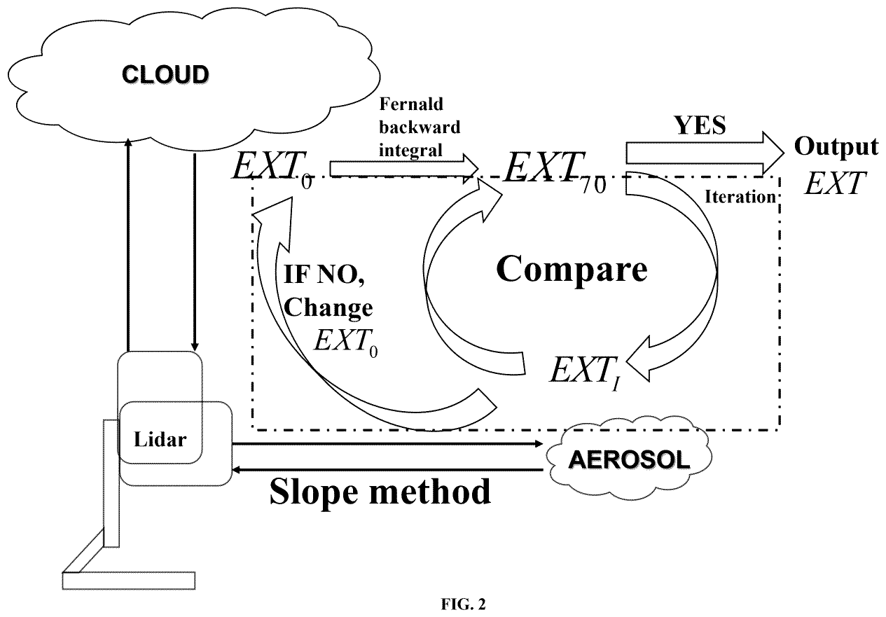

In one embodiment, the calibration point altitude at the cloud base is determined according to the range-corrected squared signal at the set moment. FIG. 2 shows a relationship between range-corrected signals obtained by experimental observation. The range-corrected squared signal at a certain moment is obtained to determine the calibration point altitude at the cloud base. The altitude of the cloud base is about 1 km. In this case, when thick clouds appear, the LIDAR cannot penetrate through the clouds. That is, an atmospheric effective echo signal above the clouds cannot be detected, and therefore, the calibration point altitude required for inversion cannot be determined from the “clean atmosphere” altitude in the traditional Fernald method. In order to invert the aerosol extinction coefficient below clouds, the cloud base at about 1.35-1.4 km is selected as the calibration point altitude in the method of the present disclosure.

The atmospheric extinction coefficient corresponding to the calibration point altitude at the cloud base is obtained as the second calibration value EXT₀. Specifically, the altitude of the clean atmosphere almost containing no atmospheric aerosol is selected as the calibration point altitude Z_{C}. The calibration point altitude Z_{C} can be determined by calculating the minimum value of a LIDAR echo signal-molecular signal ratio R(Z_{C}). The backscattering coefficient βₐ(Z_{C}) at the calibration point altitude Z_{C} is typically selected as an empirical value, which has an initial value of 1.01. In primary calculation, 1.01 is used as the target value of the LIDAR echo signal-molecular signal ratio R(Z_{C}), and the atmospheric extinction coefficient βₐ(Z_{C}) at the calibration point altitude Z_{C} is inverted from

$$R ( {Z}_{C} ) = \frac{{β}_{a} ( {Z}_{C} ) + {β}_{m} ( {Z}_{C} )}{{β}_{m} ( {Z}_{C} )} ,$$

where the molecular backscattering coefficient βₘ(Z_{C}) at the calibration point altitude Z_{C} is given in the U.S. standard atmosphere mode (which can be construed as a known value). According to the inverted backscattering coefficient βₐ (Z_{C}), a boundary value of the aerosol extinction coefficient αₐ(Z) is obtained using an aerosol extinction-to-backscatter ratio formula Sₐ. The boundary value of the aerosol extinction coefficient αₐ(Z_{C}) is the atmospheric extinction coefficient corresponding to the calibration point altitude at the cloud base and used as the second calibration value EXT₀. The aerosol extinction-to-backscatter ratio formula Sₐ have different values between 10 Sr and 90 Sr for lasers of different wavelengths. For example, the value of the aerosol extinction-to-backscatter ratio formula Sₐ is 40 for the laser of the wavelength 1064 nm. Therefore, after the laser wavelength is determined, the value of the aerosol extinction-to-backscatter ratio formula Sₐ is assured. That is, according to the inverted backscattering coefficient βₐ(Z_{C}), the boundary value of the aerosol extinction coefficient αₐ(Z_{C}) can be obtained using the aerosol extinction-to-backscatter ratio formula Sₐ.

In one embodiment, the step of obtaining the second extinction coefficient profile based on the second calibration value EXT₀ includes: the second extinction coefficient profile is obtained by a Fernald backward integration method based on the second calibration value EXT₀.

The first altitude x is greater than the blind area altitude. Specifically, the first altitude x is from 60 m to 80 m. The value of the first altitude x may be any one of 60 m, 65 m, 68 m, 70 m, 72 m, 75 m, 78 m, and 80 m. An extinction coefficient at a first altitude X is obtained as a second calibration value EXT_{X} according to the second extinction coefficient profile. When the value of the first altitude X is 60 m, the second calibration value is EXT₆₀. When the value of the first altitude X is 70 m, the second calibration value is EXT₇₀. The rest may be deduced by analogy for other altitudes.

The step of adjusting the second calibration value includes:
an increased iteration step size value of a LIDAR echo signal-molecular signal ratio R(Z_{C}) is updated as a target value of the LIDAR echo signal-molecular signal ratio R(Z_{C}); a corresponding backscattering coefficient βₐ(Z_{C}) is obtained based on the target value of the LIDAR echo signal-molecular signal ratio R(Z_{C}); and a boundary value of the aerosol extinction coefficient αₐ(Z_{C}) is obtained using an aerosol extinction-to-backscatter ratio formula Sₐ. The boundary value of the aerosol extinction coefficient αₐ(Z_{C}) is the atmospheric extinction coefficient corresponding to the calibration point altitude at the cloud base and used as the second calibration value EXT₀ corresponding to the target value.

In one embodiment, the iteration step size value ranges from 0.01 to 0.5. The smaller the iteration step size value, the more accurate the measured data.

In one embodiment, the relative error δ ranges from 0.01 to 0.05. The smaller the relative error, the more accurate the measured data.

As shown in FIG. 2, with Y=70, Sₐ=40, X=70, δ=0.01, the iteration step size value of 0.01, and the value of the relative error δ of 0.01, an inversion method of an aerosol extinction coefficient below clouds by LIDAR detection includes the following steps.

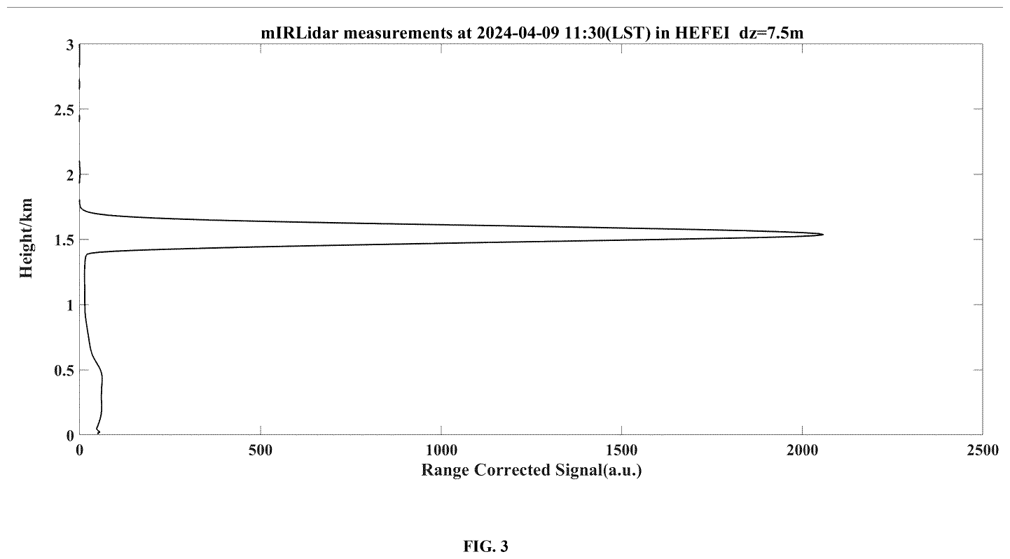

An aerosol extinction coefficient corresponding to an echo signal of LIDAR in a horizontal direction is obtained as a first calibration value EXT₁ by a slope method. By observation at 11:30 on Apr. 9, 2024, a relationship between range-corrected signals is obtained. As shown in FIG. 3, the calibration altitude at the cloud base is 1 km. According to the initial value of R(Z_{C}) of 1.01, with the known molecular backscattering coefficient βₘ(Z_{C}) at the calibration point altitude Z_{C}, the atmospheric extinction coefficient βₐ(Z_{C}) corresponding to the calibration point altitude at the cloud base is obtained as the second calibration value EXT₀.

A second extinction coefficient profile is obtained based on the second calibration value EXT₀, and an extinction coefficient at a first altitude of 70 m is obtained as a second calibration value EXT₇₀ according to the second extinction coefficient profile.

The first calibration value EXT₁ is compared with the second calibration value EXT₇₀; when |EXT₇₀−EXT₁|>EXT₁·0.01, the value of R(Z_{C}) is 1.02 based on an iteration step size, and based on the known molecular backscattering coefficient βₘ(Z_{C}) at the calibration point altitude Z_{C}, the atmospheric extinction coefficient βₐ(Z_{C}) corresponding to the calibration point altitude at the cloud base is obtained again, which is used as the adjusted second calibration value EXT₀; the step of obtaining the second extinction coefficient profile is performed based on the adjusted second calibration value EXT₀ until |EXT₇₀−EXT₁|<EXT₁·0.01, and the second calibration value EXT_{X} is output, thereby obtaining the corresponding second extinction coefficient profile. Before |EXT₇₀−EXT₁|<EXT₁·0.01, the iteration step size is increased for R(Z_{C}) on the basis of a previous value thereof. The values of R(Z_{C}) are sequentially 1.01, 1.02, 1.03 . . .

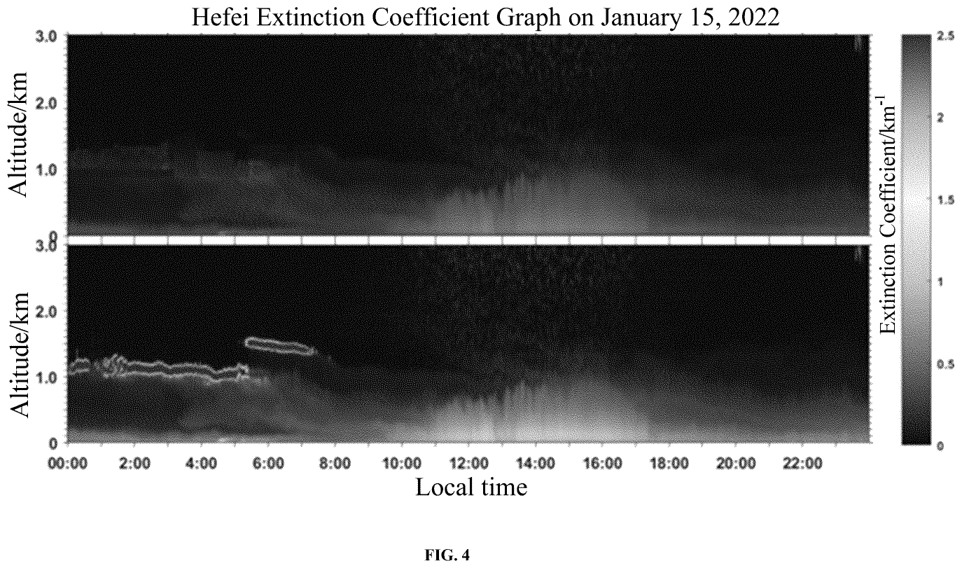

Compared with the traditional Fernald backward integration, the method of the present disclosure can clearly invert the specific detail features of the extinction coefficient below clouds. FIG. 4 illustrates, in the upper part, an extinction coefficient graph obtained through inversion of an echo signal of portable infrared LIDAR using the traditional backward integration method, and FIG. 4 illustrates, in the lower part, an extinction coefficient graph obtained through inversion of a signal of portable infrared LIDAR using the method of the present disclosure. As can be seen from the two graphs, the traditional Fernald backward integration method cannot clearly invert the position of clouds, and part of the aerosol extinction coefficient below clouds has a “blank”, including negative values. This indicates that the traditional Fernald method is obviously affected by a cloud amount and cannot accurately calibrate the echo signal of the portable infrared LIDAR, resulting in a certain error. However, based on the extinction coefficient graph obtained by the method of the present disclosure, the position of clouds and the distribution of aerosols below clouds can be inverted clearly. It can be clearly seen that the processing results of clouds and the distribution of aerosols below the clouds by the method of the present disclosure are superior to those by the traditional Fernald method. The method of the present disclosure can achieve accurate inversion of the aerosol extinction coefficient even in the presence of clouds.

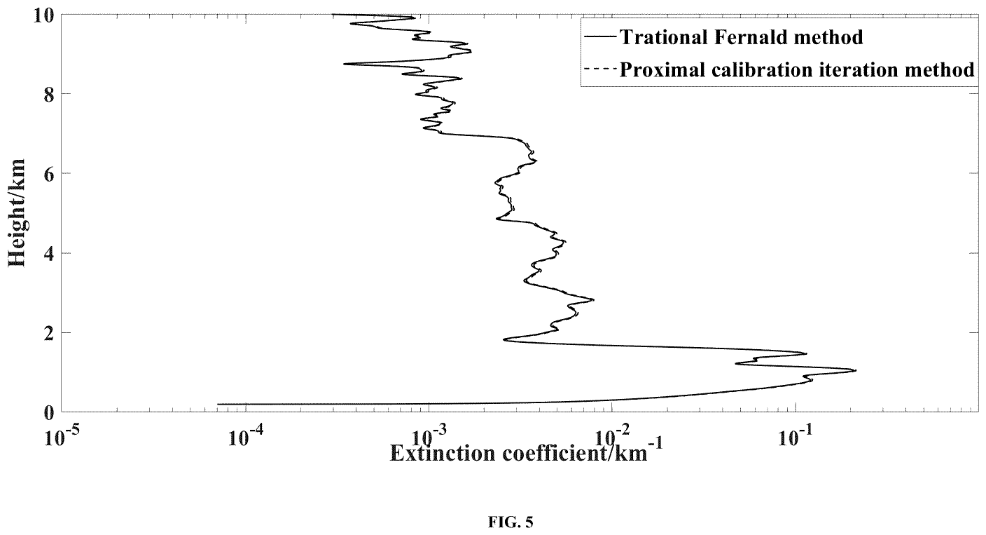

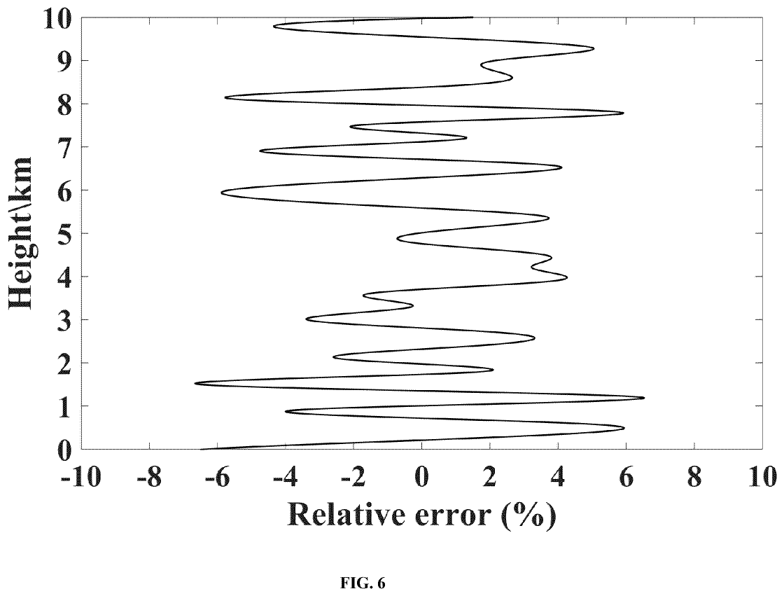

Regarding the accuracy of a verification algorithm, as shown in FIG. 5, a LIDAR echo signal at a certain moment from a high-energy radar is selected, and processed separately by the traditional Fernald backward integration method and the method of the present disclosure. By comparison, it is found that there is a little difference between the two methods. As can be known from FIG. 6, the result obtained according to the method of the present disclosure has a maximum error of about 6.5% relative to a standard value and an average relative error of less than 5%. Thus, it can be concluded that the inversion result of the method of the present disclosure is relatively accurate.

In the description of this specification, reference to the terms such as “some embodiments” or “an example” means that a specific feature, structure, material, or characteristic described in combination with the embodiment(s) or example(s) are included in at least one embodiment or example of the present disclosure. In this specification, the schematic expression of the above terms is not necessarily directed to the same embodiment or example. In addition, the specific features, structures, materials, or characteristics described may be combined in any suitable manner in any one or more embodiments. In addition, different embodiments or examples described in the specification may be joined and combined by a person skilled in the art.

The above are merely preferred embodiments of the present disclosure, which do not impose any limitation on the present disclosure. Any form of equivalent replacement or modification and the like performed on the technical solutions and technical contents disclosed by the present disclosure by those skilled in the art without departing from the technical solutions of the present disclosure do not deviate from the technical solutions of the present disclosure and still fall within the protection scope of the present disclosure.

What is claimed is:

1. An inversion method of an aerosol extinction coefficient below clouds by Light Detection and Ranging (LIDAR) detection, comprising:
obtaining an aerosol extinction coefficient corresponding to an echo signal of LIDAR in a horizontal direction as a first calibration value EXT₁; determining a calibration point altitude at a cloud base according to a range-corrected squared signal at a set moment, and obtaining an atmospheric extinction coefficient corresponding to the calibration point altitude at the cloud base as a second calibration value EXT₀;
obtaining a second extinction coefficient profile based on the second calibration value EXT₀, and obtaining an extinction coefficient at a first altitude X as a second calibration value EXT_{X} according to the second extinction coefficient profile, the first altitude X being greater than a blind area altitude;
comparing the first calibration value EXT₁ with the second calibration value EXT_{X}, adjusting the second calibration value EXT₀ when |EXT_{X}−EXT₁|>EXT₁·8, performing the obtaining a second extinction coefficient profile based on the adjusted second calibration value EXT₀ until |EXT_{X}−EXT₁|<EXT₁·δ, and outputting the second calibration value EXT_{X}, wherein δ is a relative error.

2. The inversion method of an aerosol extinction coefficient below clouds by LIDAR detection according to claim 1, wherein the obtaining an aerosol extinction coefficient corresponding to an echo signal of LIDAR in a horizontal direction as a first calibration value EXT₁ comprises: obtaining, by a slope method, the aerosol extinction coefficient corresponding to the echo signal of the LIDAR in the horizontal direction as the first calibration value EXT₁.

3. The inversion method of an aerosol extinction coefficient below clouds by LIDAR detection according to claim 2, wherein the obtaining, by a slope method, the aerosol extinction coefficient corresponding to the echo signal of the LIDAR in the horizontal direction as the first calibration value EXT₁ comprises:
assuming that the atmosphere is horizontally homogeneous, defining an atmospheric backscattering echo signal power P(Y) at a horizontal range Y received by the LIDAR as:
$$P ( Y ) = {P}_{t} {kY}^{2} {β}_{H} exp ( - 2 {α}_{H} Y ) \qquad ( 2 )$$
wherein Pₜ represents a laser emission power (W), k represents a radar system constant (W·km³·Sr), β_{H} represents a horizontal atmospheric backscattering coefficient (km⁻¹Sr⁻¹), and α_{H} represents a horizontal atmospheric extinction coefficient (km⁻¹);
multiplying both sides of the formula (2) by a range square, and then taking a logarithm and taking a derivative to obtain:
$$\frac{d ( ln [ P ( Y ) {Y}^{2} ] )}{dY} = \frac{1}{β} \frac{d β}{dY} - 2 {α}_{H} \qquad ( 3 )$$
under a condition of the horizontally homogeneous atmosphere, dβ/dz=0, and obtaining:
$${α}_{H} = - \frac{1}{2} \frac{d ( ln [ P ( Y ) {Y}^{2} ] )}{dY} \qquad ( 4 )$$
performing least squares fitting on ln[P(Y)Y²] and Y, determining a half of a slope as the horizontal atmospheric extinction coefficient α_{H}, and using α_{H} as the first calibration value EXT₁.

4. The inversion method of an aerosol extinction coefficient below clouds by LIDAR detection according to claim 1, wherein the obtaining a second extinction coefficient profile based on the second calibration value EXT₀ comprises: obtaining, by a Fernald backward integration method, the second extinction coefficient profile based on the second calibration value EXT₀.

5. The inversion method of an aerosol extinction coefficient below clouds by LIDAR detection according to claim 1, wherein the horizontal range Y coverable by the LIDAR is from 60 m to 1000 m.

6. The inversion method of an aerosol extinction coefficient below clouds by LIDAR detection according to claim 1, wherein the first altitude X is greater than the blind area altitude, and the first altitude X is from 60 m to 1000 m.

7. The inversion method of an aerosol extinction coefficient below clouds by LIDAR detection according to claim 1, wherein the adjusting the second calibration value EXT₀ comprises:
updating an increased iteration step size value of a LIDAR echo signal-molecular signal ratio R(Z_{C}) as a target value of the LIDAR echo signal-molecular signal ratio R(Z_{C}), obtaining a corresponding backscattering coefficient βₐ(Z_{C}) based on the target value of the LIDAR echo signal-molecular signal ratio R(Z_{C}), and obtaining a boundary value of the aerosol extinction coefficient αₐ(Z) using an aerosol extinction-to-backscatter ratio formula Sₐ, the boundary value of the aerosol extinction coefficient αₐ(Z_{C}) being the atmospheric extinction coefficient corresponding to the calibration point altitude at the cloud base and used as the second calibration value EXT₀ corresponding to the target value.

8. The inversion method of an aerosol extinction coefficient below clouds by LIDAR detection according to claim 7, wherein the iteration step size value ranges from 0.01 to 0.5.

9. The inversion method of an aerosol extinction coefficient below clouds by LIDAR detection according to claim 7, wherein the LIDAR echo signal-molecular signal ratio R(Z_{C}) has an initial value of 1.01.

10. The inversion method of an aerosol extinction coefficient below clouds by LIDAR detection according to claim 1, wherein the relative error δ ranges from 0.01 to 0.05.
